(19) United States
(12) Patent Application Publication
(10) Pub. No.: US 2009/0233481 A1
(43) Pub. Date: Sep. 17, 2009

(54) Vehicle

(75) Inventors: Günther Messerschmid, Offenbach (DE); Pedro Moreno-Romero, Offenbach (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: CASCO SCHOELLER GmbH, Frankfurt am Main (DE)

(21) Appl. No.: 11/718,077

(22) PCT Filed: Jan. 7, 2006
(86) PCT No.: PCT/EP06/00079

§ 371 Date: Apr. 26, 2007

(30) Foreign Application Priority Data
Jan. 7, 2005 (DE) 05000191.6

(51) Int. Cl. H01R 13/73; H01R 24/00; H01R 13/648; H04W 4/00; H04B 7/00

(52) U.S. Cl. 439/562; 439/660; 439/607.01; 439/544; 370/338; 455/41.2

(57) ABSTRACT

The invention relates to a vehicle, particularly an automobile (100), comprising an on-board supply system (1′), at least one peripheral device (1), and at least one socket (2, 2b, 2c, 2d) for connecting user terminals (5), such as notebooks, mobile telephones, pocket PCs, handheld devices, and similar, to the at least one peripheral device (1), e.g. a multifunctional infotainment module, and the on-board supply system (1′) of the vehicle. According to the invention, the housing (4) of the at least one socket (2, 2b, 2c, 2d) is provided with a recess (4a) which is located on the side facing the plug and in which at least one connection (3a) that is connected to a power conductor (6) of the vehicle for supplying the user terminals (5) with power and at least one connection (3b) that is connected to a data line (6) of the vehicle for transmitting data between the user terminals (5) and the at least one peripheral device (1) are disposed. The power conductor (6) is electrically connected to the on-board power system (1′) while the data line (6) is connected to the peripheral device (1).

The present invention relates to a vehicle, in particular a passenger car, with at least one peripheral device and at least one socket for the connection of user terminals to the at least one peripheral device, a vehicle being understood to mean land vehicles, watercraft, aircraft, spacecraft and other vehicles.

High-grade multimedia components can be the deciding factor for the acquisition of a particular new vehicle in the passenger car sector. Virtually every passenger car manufacturer now offers navigational devices, high-end entertainment electronics and hands-free devices for all models, even for models in the compact-vehicle series. The automotive groups are already offering customers with purchasing power complex car infotainment modules operated by powerful microchips which, apart from important vehicle information, also display dynamic navigational charts on central LC displays in the dashboard and permit access to telecommunications functions, entertainment features and Internet services.

With the ever-increasing degree of technology in the interior of present-day series-production passenger cars, the installation space in the interior of the passenger car provided for the installation of various entertainment and information elements is also diminishing.

Despite the ever-increasing incorporation of entertainment and information elements in the interior of series-production passenger cars, communication between various entertainment and information elements and user terminals, such as for example notebooks, mobile telephones, pocket PCs, handheld devices etc., for example for the transmission of user data, such as for example navigational charts or music files etc., is not possible.

Only by means of a suitable car adapter for the socket of a cigarette lighter can such user terminals be connected in present-day series-production passenger cars to such a socket, for example in the dashboard or in the central console of a passenger car, for the power supply of the terminals through the car's on-board supply system.

The connection unit, comprising the car adapter for the socket of the cigarette lighter, a plug which can be inserted into the car adapter and the socket of the cigarette lighter, also has relatively large dimensions, which are a drawback for the interior of passenger cars especially with a view to future vehicle developments, because the interior of passenger cars requires the smallest possible connection units on account of the increasingly narrower space conditions.

The problem underlying the invention, therefore, is to make available a vehicle, in particular a passenger car, wherein the aforementioned communication between various entertainment and information elements and user terminals is possible.

The solution to this problem takes place according to the invention with the features stated in claim 1. Preferred embodiments of the invention are the subject-matter of the sub-claims.

The vehicle according to the invention, in particular a passenger car, comprises an on-board supply system, at least one peripheral device and at least one socket with a housing for the connection of various user terminals, such as for example notebooks, mobile telephones, pocket PCs, handheld devices etc., to the at least one peripheral device, for example an infotainment system, wherein the at least one socket, together with a plug suitably connectable to the socket, forms a socket-plug arrangement. The housing of the at least one socket has a recess on the plug side, in which recess there is disposed at least one connection, which is connected to a power conductor of the vehicle, for supplying the user terminals with power, as well as at least one connection, which is connected to a data line of the vehicle and is separate from the power connection, for transmitting data between the user terminals and the at least one peripheral device. The power conductor is connected electrically to the on-board supply system and the data line is connected electrically to the peripheral device.

The vehicle according to the invention therefore enables the aforementioned communication between various entertainment and information elements and the user terminals, wherein a user terminal, when connected to the at least one socket of the vehicle, is able at the same time to be supplied with power through the vehicle on-board supply system by reason of the at least one power connection of the socket, said power connection being separate from the data connection.

As a result of the fact that the at least one socket has at least one power connection and at least one data connection separate from the latter, said socket is based on at least a dual function, which enables bi-directional communication between the user terminals and the at least one peripheral device with simultaneous power supply of at least one of the user terminals through the vehicle on-board supply system.

In a preferred embodiment of the invention, the housing of the at least one socket is formed from an electrically shielding material for the protection of the socket against electrical or magnetic interference fields. If the housing is not made of metal, it is either designed as a frame-shaped plastic housing filled with casting compound or as an injection-moulded plastics part.

In order to install the at least one socket in the interior of the vehicle according to the invention, the housing of the same is preferably provided on the plug side with a frame-shaped shoulder, which serves as a stop element.

In a further preferred embodiment of the invention, the at least one connection of the at least one socket connected to the power conductor of the vehicle and the at least one connection of the at least one socket connected to the data line of the vehicle have pins which can be connected in a snap-in fashion to the corresponding pins of the connections of the plug connectable to the socket. According to the invention, this thus avoids contact between the pins of the socket and the pins of the plug being interrupted on account of vibrations of the vehicle after insertion of the plug into the socket.

The pins of the connections of the socket are in each case preferably designed solid, so that the respective pins of the connections of the plug, which latter pins are designed correspondingly hollow-shaped, can be fitted onto the pins of the connections of the socket, the pins designed solid each preferably being provided with at least one bulge, which engages in a snap-in fashion in a corresponding recess of the plug pin designed hollow-shaped.

Both the bulge of the socket pin and the corresponding recess of the plug pin are expediently designed spherical, with the result that relative moments between the plug pin and the socket pin owing to vibrations of the vehicle are compensated for in the best possible manner.

The pins of the connections of the socket preferably have a rectangular cross-section. In principle, however, round pin cross-sections or other cross-sectional shapes are also conceivable for the pins.

The socket pins are preferably produced from spring steel. In principle, however, other materials are conceivable for the socket pins.

In a further preferred embodiment of the invention, the at least one connection of the at least one socket connected to the data line of the vehicle is designed as a USB connection for user USB applications.

This enables user USB applications, in particular car USB applications, for example the connection of mobile computers (notebooks, pocket PCs, handheld devices etc.) to the on-board computer, the connection of the on-board telephone to mobile telephones, the connection of car infotainment modules to mobile computers, the connection of devices for playing digital audio files to on-board audio systems or the connection of on-board navigational systems to mobile computers and suchlike.

Moreover, the user terminals for communication with vehicle and periphery systems can be connected to vehicle-internal data bus systems, e.g. LIN-bus, CAN-bus.

In a further preferred embodiment of the invention, the at least one power connection of the socket and the at least one data connection of the socket are connected by means of cables to the power conductor and the data line of the vehicle according to the invention.

As an alternative to this, the at least one socket could be formed on the vehicle periphery side as a flat plug, so that the plug connections of the at least one socket could be connected to flat pins or more precisely flat-plug pins.

In a further preferred embodiment of the invention, the housing of the at least one socket is provided with means for the mechanical locking in position and/or clamping of the same at the installation point in the interior of the vehicle, thus for example to an installation point in the dashboard or in the central console. This is intended to avoid a spontaneous detachment of the socket on account of vibrations of the vehicle or unintentional tugging-out of the socket by the vehicle occupants.

The housing of the at least one socket is preferably provided with at least one locking tongue or clamping tongue as a means for the mechanical locking in position and/or clamping of the same, said means preferably being designed in one piece with the housing of the socket.

In a further preferred embodiment of the invention, the at least one socket is equipped with a light source for illuminating the recess of the housing. The light source of the at least one socket can be an incandescent lamp, a light-emitting diode (LED) or a light guide.

In a further preferred embodiment of the invention, the at least one socket is equipped with at least one further connection as an integral component of the same for the charging of further user terminals.

The socket according to the invention is characterised by its very small dimensions, for which reason it is particularly well suited for the aforementioned multimedia applications, in particular with a view to future vehicle developments.

Furthermore, the at least one socket of the vehicle according to the invention represents an open system which, apart from the preferred application in passenger cars, offers a variety of possible applications in various vehicles, in particular future vehicles. For example, the at least one socket of the vehicle according to the invention could also be installed for user or passenger use in aircraft seats of civil air traffic for communication between peripheral devices of a civil aircraft and user or passenger terminals, a user terminal being able at the same time to be supplied with power through the aircraft on-board supply system during the communication with a peripheral device.

Examples of embodiment of the invention are explained in detail below by reference to the drawings. In the figures:

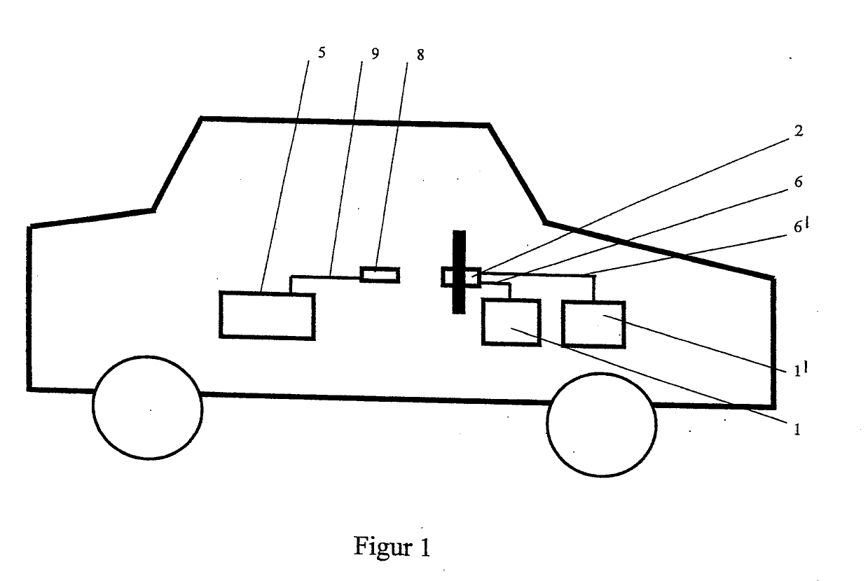

FIG. 1 shows a schematic representation of a vehicle according to the invention with an on-board supply system, at least one peripheral device and at least one socket for the connection of user terminals to the at least one peripheral device,

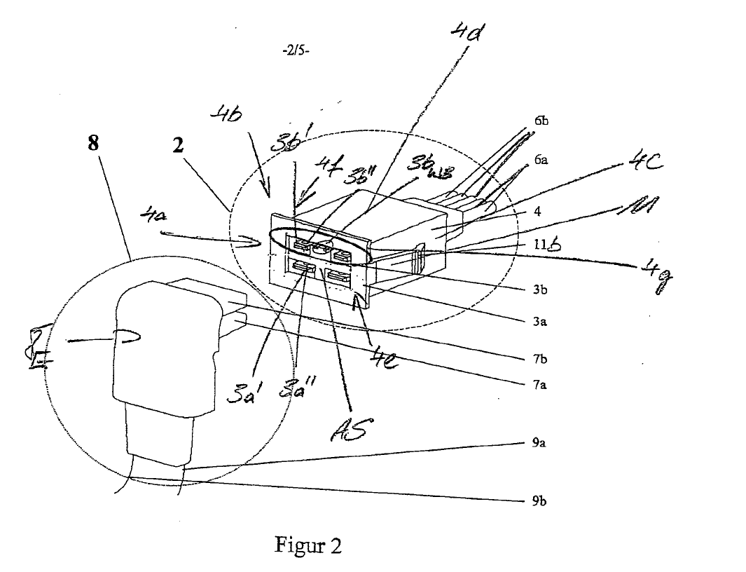

FIG. 2 shows a perspective view of an embodiment of the socket from FIG. 1 and a plug connectable to this socket,

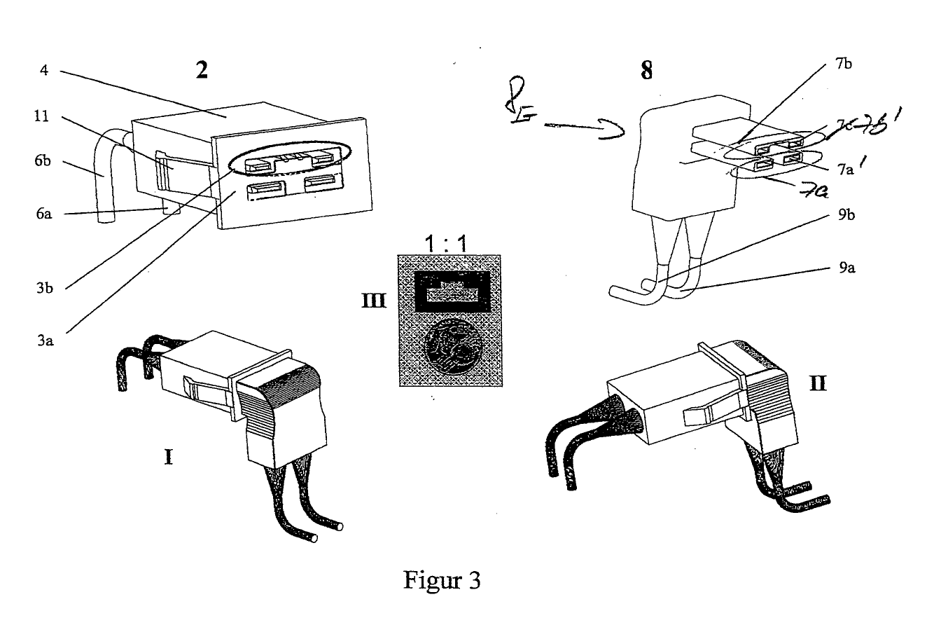

FIG. 3 shows a further perspective view of the socket and the plug from FIG. 2,

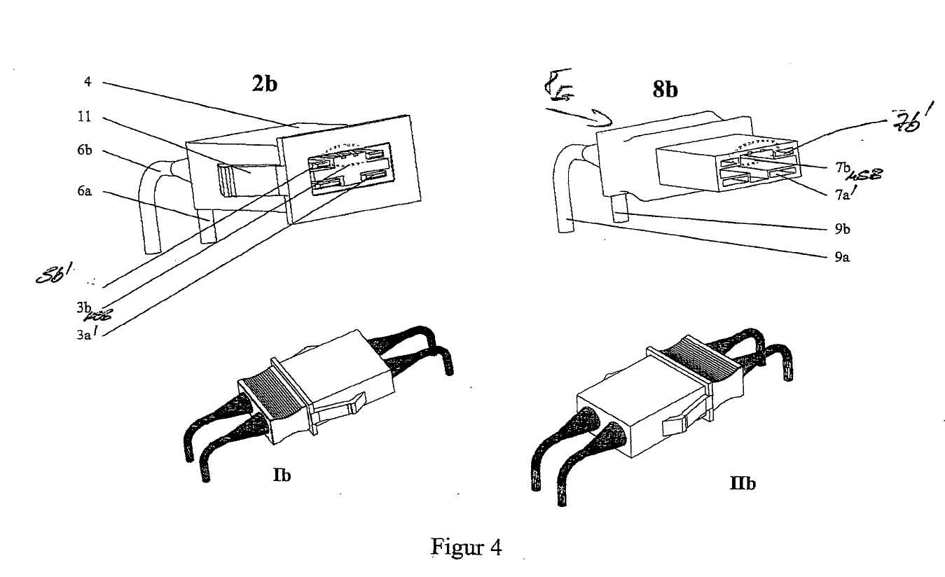

FIG. 4 shows a perspective view of an alternative embodiment of the socket from FIG. 1 and a plug connectable to this socket, and

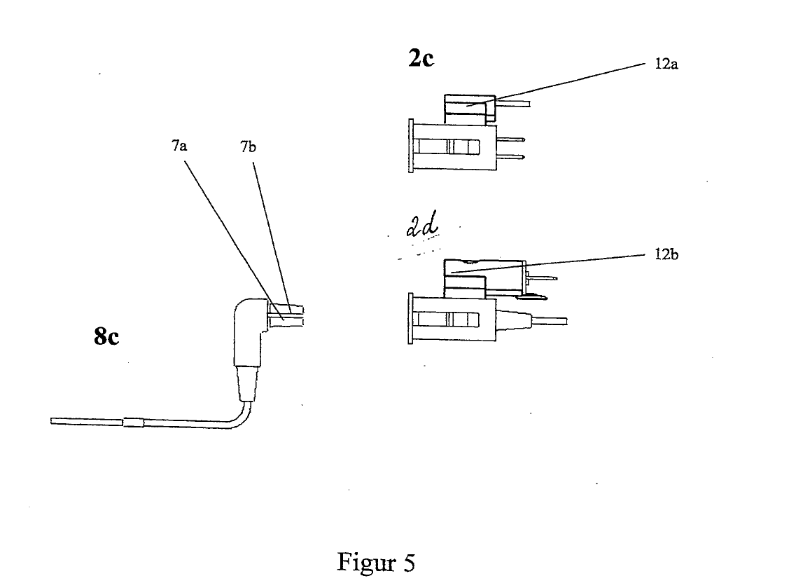

FIG. 5 shows a side view of two further alternative embodiments of the socket from FIG. 1 with an additional connection as an integral component of the socket for supplying further user terminals with power and a plug connectable to these sockets.

As can be seen from the schematic representation of passenger car 100 according to the invention in FIG. 1, socket 2, 2b, 2c, 2d is on the one hand connected via power conductor 6′ of the vehicle electrically to on-board supply system 1′ or to the vehicle battery and on the other hand via a data line 6 of the vehicle electrically to peripheral device 1, for example an infotainment system. User terminals 5, such as for example notebooks, mobile telephones, pocket PCs, handheld devices and suchlike, in the interior of passenger car 100, can be connected by means of a line 9, which comprises both a power conductor 9a and also a USB data line 9b separate from the latter, and a plug 8, 8b, 8c connectable to socket 2, 2b, 2c, 2d for bi-directional communication with peripheral device 1 with simultaneous power supply through vehicle on-board supply system 1′.

Socket 2, 2b, 2c, 2d has a box-shaped housing 4 with in each case two narrow longitudinal sides 4c and in each case two wide longitudinal sides 4d, which housing is provided on the plug side with a rectangular frame-shaped shoulder 4b projecting both beyond the two narrow and also wide longitudinal sides 4c, 4d, which shoulder is designed slim, i.e. is thin walled, in the longitudinal direction of housing 4. This shoulder 4b serves as a stop element, up to which socket 2, 2b, 2c, 2d is inserted into an opening correspondingly provided for this at an installation point in the interior of vehicle 100 according to the invention, for example at a point in the dashboard or in the central console, so that plane longitudinal side 4f of shoulder 4b facing away from plug-side plane longitudinal side 4e lies adjacent to a wall. Extending from short end faces 4g of shoulder 4b along the two narrow longitudinal sides 4c of housing 4 is in each case a locking or clamping tongue 11, which is preferably designed in one piece with shoulder 4b. These two locking or clamping tongues 11 serve to lock socket 2, 2b, 2c, 2d in position with a wall inside the opening at the installation point, wherein, for the locking in position, a snap-in nose 11b on in each case one of the two locking and clamping tongues 11 engages behind a projection of the wall provided for the purpose. On the other hand, these locking and clamping tongues 11 also clamp socket 2, 2b, 2c, 2d against this wall, in that the latter are bent with respect to shoulder 4b when socket 2, 2b, 2c, 2d is inserted into the opening.

A cross-shaped connection piece AS inserted into housing 4 divides plug-side rectangular recess 4a, or more precisely the plug-side rectangular connection region of socket 2, 2b, 2c, 2d, into four rectangular sub-regions, in which in each case a rectangular pin 3a′, 3b′ is disposed. The two lower pins 3a′, in the perspective view of socket 2, 2b, form a first, primary power connection 3a for supplying user terminals 5 with power through vehicle on-board supply system 1′. Depending on the preferred use of these sockets 2, 2b, 2c, 2d in passenger cars or lorries, power connection 3a makes available a current of preferably 10 to 15 A, but a maximum of 20 A, with an on-board system voltage of preferably 14 V for passenger cars and preferably 28 V for lorries. In contrast, the two upper pins 3b′, in the perspective view of socket 2, 2b, form a second, secondary power connection which, in conjunction with the two pins 3b_{USB} for bi-directional transmission of data between user terminals 5 and the at least one peripheral device 1, forms a USB connection. The two pins 3b_{USB} are arranged between the two pins 3b′ at a side of connection piece AS which is facing upper wide longitudinal side 4d of housing 4 in the perspective view of socket 2, 2b. Since socket 2, 2b comprises both a power connection 3a as well as a USB data connection 3b separate from the latter, said socket is based on a dual function, which enables bi-directional communication between user terminals 5 and peripheral device 1 with a simultaneous power supply of user terminals 5 through vehicle on-board supply system 1′.

Pins 3a′, 3b′ of socket 2, 2b are designed in such a way that they can be connected in a snap-in manner to corresponding pins 7a′, 7b′ of plug 8, 8b connectable to socket 2, 2b. Pins 3a′, 3b′ are preferably designed solid, so that respective pins 7a1, 7b, of plug 8, 8b which are correspondingly designed hollow-shaped can be placed onto pins 3a′, 3b′ of socket 2, 2b, pins 3a′, 3b′ designed solid each being provided with at least one hemispherical bulge 3a″, 3b″, which engages in a snap-in manner into a corresponding hemispherical recess of pins 7a′, 7b′ designed hollow-shaped. This snap-in embodiment of pins 3a′, 3b′, 7a′, 7b′ not only serves to secure plug 8, 8b against tensile loads, which can act on the same, but rather for continuously securing the contact between pins 3a′, 3b′, 7a′, 7b′ after the insertion of plug 8, 8b into socket 2, 2b even in the presence of vibrations of vehicle 100 according to the invention.

Socket pins 3a′, 3b′, 3b_{USB} are preferably produced from spring steel, whereas plug pins 7a′, 7b′can be produced for example from a bronze material. This enables a reliable connection of pins 3a′, 3b′, 7a′, 7b′. Preferably, plug pins 7a′, 7b′ are also designed conical, in order to facilitate the insertion of plug 8, 8b into socket 2, 2b, 2c, 2d for the vehicle occupants during a journey.

The two lower pins 3a′ forming power connection 3a of socket 2, 2b, 2c, 2d in the perspective view of the socket are connected to a cable 6a, which for its part is connected to a power conductor 61 of passenger car 100 according to the invention. In contrast, upper pins 3b′ and 3b_{USB} forming USB data connection 3b are connected to a cable 6b with a metallic base material as a medium for the transmission of information signals, which for its part is connected to USB data line 6 of passenger car 100 according to the invention.

In principle, however, both data connection 3b of socket 2, 2b, 2c, 2d and also cable 6b and data line 6 of passenger car 100 according to the invention can also be designed as optical waveguides, for example made from a plastic fibre.

The lower halves of FIGS. 3 and 4 each depict two different perspective views I, Ib, II, IIb of the socket-plug arrangement. In addition, a comparison III of the socket and a 1 Euro cent coin are depicted in the middle of FIG. 3 to illustrate the relatively small installation dimensions upon which socket 2, 2a is based.

Socket 2, 2b, 2c, 2d of passenger car 100 according to the invention is suitable, on account of its very small installation dimensions, for installation in passenger cars equipped with entertainment and information systems and multimedia systems, dashboards, central consoles or seats of the passenger car coming into consideration as possible installation points. Particularly with regard to future vehicles or passenger car developments, socket 2, 2b, 2c, 2d of passenger car 100 according to the invention will meet the strict requirement for small installation dimensions due to the ever increasing incorporation of entertainment and information elements in the interior of passenger cars.

In an alternative embodiment of passenger car 100 according to the invention, socket 2c, 2d is equipped with a further connection 12a, 12b as an integral component of the same (FIG. 5), so that, apart from plug 8c connectable to socket 2c, 2d, a further plug can be connected to socket 2c, 2d, possibly by means of a suitable adapter, for the charging of further user terminals, for example a mobile telephone, through vehicle on-board supply system 1′. In contrast with socket 2, 2d represented in FIGS. 2, 3 and 4, this socket 2c, 2d is therefore based on a threefold function. The housing of connection 12a, 12b is preferably designed as an injection-moulded plastics part.

Housing 4 of socket 2, 2b, 2c, 2d is preferably made from an electrically shielding, metallic material for the protection of socket 2, 2b, 2c, 2d against electrical or magnetic interference fields. The electromagnetic compatibility of socket 2, 2b, 2c, 2d is thus improved, with the result that functional disturbances between the vehicle periphery environment, i.e. the at least one peripheral device 1, and the vehicle interior environment, i.e. user terminal 5, due to the irradiation of electromagnetic waves of user terminal 5, which are radiated onto socket 2, 2b, 2c, 2d, are reduced. The electromagnetic compatibility of socket 2, 2b, 2c, 2d could however also be improved by making available a suitable, metallic counter-coupling by means of plug 8, 8b, 8c itself, since the connections of socket 2, 2b, 2c, 2d can also be shielded against the irradiated electromagnetic waves when plug 8, 8b, 8c is inserted into socket 2, 2b, 2c, 2d. For this purpose, housing 8_{G} of plug 8, 8b, 8c itself would have to be made from a suitably shielding, metallic material, which covers connection 3b_{USB} of socket 2, 2b, 2c, 2d when plug 8, 8b, 8c is inserted into socket 2, 2b, 2c, 2d. Consequently, such functional interferences could be reduced much better or even avoided. In this connection, it would of course be even better if all the user components themselves of the vehicle interior environment, i.e. user devices 5, cable 9 and plug 8, 8b, 8c insertable into socket 2, 2b, 2c, 2d, were shielded similar to the vehicle periphery environment, in which in general all strongly irradiating electrical devices including the cable strands are in each case themselves shielded. This represents, as it were, an optimum. The best possible shielding against irradiation and radiation of electromagnetic waves would be achieved in this way, in order to reduce to the greatest possible extent or even avoid functional interferences between the vehicle interior environment and the vehicle periphery environment.

In a further alternative embodiment of passenger car 100 according to the invention, socket 2, 2b, 2c, 2d is also equipped with a light source for illuminating plug-side recess 4a, an incandescent lamp, a light-emitting diode (LED) or a light guide being conceivable as a light source. For optical reasons, socket 2, 2b, 2c, 2d also has a cover for covering the same when not in use.

In a further alternative embodiment of passenger car 100 according to the invention, socket 2, 2b, 2c, 2d is also equipped with a wireless radio interface for wireless communication between user terminals 5 and the one peripheral device 1. The wireless interface is preferably designed as an infrared radio interface for infrared communication between user terminals 5 and the one peripheral device 1 over a short distance.

In principle, however, a Bluetooth USB interface is also conceivable as a radio interface for radio communication, said Bluetooth USB interface being a component of a WLAN radio network (Wireless Local Area Network).

1. A vehicle with an on-board supply system, at least one peripheral device and at least one socket with a housing for the connection of user terminals to the at least one peripheral device, wherein the socket, together with a plug suitably connectable to the socket, forms a socket-plug arrangement, characterised in that the housing of the at least one socket has a recess on the plug side, in which recess there is disposed at least one connection, which is connected to a power conductor of the vehicle, for supplying the user terminals with power, as well as at least one separate connections, which is connected to a data line of the vehicle, for transmitting data between the user terminals and the at least one peripheral device, wherein the power conductor is connected electrically to the on-board supply system and the data line to the peripheral device.

2. The vehicle according to claim 1, characterised in that the housing of the at least one socket is formed from an electrically shielding material for the protection of the socket against electrical or magnetic interference fields.

3. The vehicle according to claim 1, characterised in that the housing of the at least one socket has on the plug side a frame-shaped shoulder as a stop element for the installation in the interior of the vehicle.

4. The vehicle according to claim 1, characterised in that the at least one connection connected to the power conductor and the at least one connection of the at least one socket connected to the data line have pins, which can be connected in a snap-in manner to the corresponding pins of the connections of the plug connectable to the socket.

5. The vehicle according to claim 4, characterised in that the pins of the connections of the socket are in each case designed solid, so that the respective pins of the connections of the plug, which latter pins are designed correspondingly hollow-shaped, can be fitted onto the pins of the connections of the socket, the pins designed solid each being provided with at least one bulge, which engages in a snap-in fashion in a corresponding recess of the plug pin designed hollow-shaped.

6. The vehicle according to claim 5, characterised in that the bulge and the corresponding recess are designed spherical.

7. The vehicle according to claim 5, characterised in that the pins of the connections of the socket have a rectangular cross-section.

8. The vehicle according to claim 1, characterised in that the at least one connection of the at least one socket connected to the data line is designed as a USB connection.

9. The vehicle according to claim 1, characterised in that the connections of the at least one socket are made from spring steel.

10. The vehicle according to claim 1, characterised in that the at least one connection of the socket connected to the power conductor of the vehicle is connected to cables or flat pins for connecting the connection to the power conductor and the at least one connection of the socket connected to the data line of the vehicle is connected to cables or flat pins for connecting the connection to the data line.

11. The vehicle according to claim 1, characterised in that the housing of the at least one socket is provided with means for the mechanical locking in position and/or clamping of the same in the interior of the vehicle.

12. The vehicle according to claim 11, characterised in that the means for the mechanical locking in position and/or clamping comprise at least one locking tongue.

13. The vehicle according to claim 1, characterised in that the at least one socket is equipped with a light source for illuminating the recess.

14. The vehicle according to claim 13, characterised in that the light source of the at least one socket is an incandescent lamp, a light-emitting diode (LED) or a light guide.

15. The vehicle according to claim 1, characterised in that the at least one socket is equipped with at least one further connection, as an integral component of the same for the charging of further user terminals.

16. The vehicle according to claim 1, characterised in that the at least one socket has a wireless interface for wireless communication between the user terminals and the at least one peripheral device.

17. The vehicle according to claim 16, characterised in that the wireless interface is an infrared interface for infrared communication between the user terminals and the at least one peripheral device over a short distance.

18. The vehicle according to claim 16, characterised in that the wireless interface is a radio interface for radio communication between the user terminals and the at least one peripheral device over a short distance.

19. The vehicle according to claim 18, characterised in that the radio interface is a Bluetooth USB interface.

20. The vehicle according to claim 16, characterised in that the wireless interface is a radio interface for radio communication between the user terminals and the at least one peripheral device in a local WLAN radio network (Wireless Local Area Network).
